(19) United States
(12) Patent Application Publication
(10) Pub. No.: US 2017/0245486 A1
(43) Pub. Date: Aug. 31, 2017

(54) FISHING SYSTEM

(71) Applicants: Rick Larson, Hanford, CA (US); Marque Lundgren, Hanford, CA (US)

(72) Inventors: Rick Larson, Hanford, CA (US); Marque Lundgren, Hanford, CA (US)

(21) Appl. No.: 15/053,153

(22) Filed: Feb. 25, 2016

(51) Int. Cl. A01K 97/06; A01K 97/10; A45B 11/00; A47C 1/14; A47C 7/62; A47C 7/00; A47C 7/40; A47C 7/72; B65D 43/16; B65D 51/24; B65D 25/28; B65D 25/04; B65D 81/38; F25D 3/08; A47G 23/02; A47J 47/00; H04R 1/02; A01K 97/04

(52) U.S. Cl. CPC A01K 97/06; A01K 97/04; A01K 97/10; A45B 11/00; A47C 1/14; A47C 7/62; A47C 7/006; A47C 7/407; A47C 7/72; B65D 43/16; B65D 51/24; B65D 25/28; B65D 25/04; B65D 81/3813; F25D 3/08; A47G 23/02; A47J 47/005; H04R 1/028

(57) ABSTRACT

A fishing system comprising an insulated housing defining an upper compartment and a lower compartment, wherein the upper compartment of the housing comprises a removable cooling chest, a lid hingedly attached to a top edge of the rear wall and a cutting board attached to an exterior surface of the lid. A plurality of fishing pole holders, which allow fishing pole to be set in different angles for fishing from a seated position. The lower compartment of the housing comprises a plurality of easily accessible tray holders for receiving fishing tackle trays and bait boxes, and a pair of wheels attached to a bottom of the rear wall for easy transportation of the fishing system.

### BACKGROUND OF THE DISCLOSURE

### A. Technical Field

The present disclosure generally relates to storage and portability of fishing equipment and fishing related accessories, and more specifically relates to a fishing system comprising a wide range of accessories, which offers a fishing experience that requires only limited use of hands.

### B. Description of Related Art

Generally, an outdoor fishing trip requires transportation of a substantial amount of individual fishing related equipment to the fishing area. For example, the equipment generally includes, fishing rods and reels, tackle box, folding chairs or stools, folding table, bait containers, a cooler for food and drinks, multiple containers to store the day's catch, a fish net, portable electronic entertainment devices and the like. Various types of combination fishing tackle boxes have been devised over the years to organize fishing equipment and other items and to provide lot more comfort to users, particularly during long hours of waiting.

Traditional fishing boxes have often included compartmentalized areas for separate storage of fishing lures of different types in order to avoid entangling of lures. These boxes are usually top loading type, which proves inconvenient to access the stored fishing tackle while remaining in a seated position. Moreover, it does not offer any support for holding fishing rods and other accessories such as separate holders for food and beverages. In addition, conventional fishing tackle boxes do not offer any protection to the user from harsh weather conditions such as sunny or rainy days. One needs to carry a foldable chair or stool separately for sitting and resting comfortably.

It is a cumbersome process to source, arrange and transport the fishing equipment and other items required for a fishing trip to a fishing site. Though combination of storage container and seat are known in the art, these combined seat boxes are known to consist of familiar, expected, and obvious structural configurations, which lack additional features to fulfill user objectives and requirements. In addition, the existing fishing boxes allows carrying and storing of a selective list of items with limited ease of access in retrieving an item.

Therefore, there is a need in the art for a fishing system, which allows fishing from a comfortable seated position, requiring only limited use of hands and easy access to a wide range of fishing supplies and accessories stored in one convenient container.

### SUMMARY OF THE DISCLOSURE

The present disclosure relates to a fishing system comprising an insulated housing defining an upper compartment and a lower compartment. The upper compartment of the housing comprises a removable cooling chest, a lid hingedly attached to a top edge of the rear wall and a cutting board attached to an exterior surface of the lid. The housing further comprises a cushion pad seat removably attachable to the cutting board. A plurality of fishing pole holders pivotally attached to front corners of the housing, configured to receive and set fishing pole in predefined angles, which allow fishing in different types of water body from a seated position. The lower compartment of the housing comprises a plurality of tray holders for receiving fishing tackle trays and bait boxes, and a pair of wheels attached to a bottom of the rear wall for easy transportation of the fishing box.

In an embodiment, the fishing system further comprises a backrest foldably attached to the rear wall of the housing offering a comfortable seating position. A cushion pad removably attached to the exterior of the lid or configured to be positioned on top of the cutting board. The fishing system further comprises an armrest pivotally attached to an upper edge of the first sidewall and the second sidewall. A retractable handle and an umbrella attached to the rear wall of the housing. A Bluetooth speaker is incorporated within the first sidewall and/or second sidewall.

The fishing system of the present disclosure allows carrying all fishing supplies and other items needed for a fishing trip in one convenient container. In addition, the fishing box provides a comfortable seating arrangement and allows easy access to fishing tackle and accessories. The cooling chest allows storing of food and beverages, ice, water and bait. The cooling chest is removable for cleaning and sanitation purposes. The cooling chest is made of a material suitable for dishwasher and commonly used cleaning liquids. The cutting board offers a convenient platform for cleaning and preparing the fresh catch for cooking. The fishing system comprises one or more tool bags with a plurality of pouches hang from the sidewalls, for storing handy mechanical tools and cutting devices.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF DIFFERENT VIEWS OF DRAWINGS

FIG. 1 is a front view of the fishing system according to an embodiment of the present disclosure.

FIG. 2 is a top perspective view of the removable cooling chest with a lid.

FIG. 3 is a top perspective view of the removable cooling chest with compartments.

FIG. 4 is a side perspective view of the fishing system comprising a cutting board on top.

FIG. 5 is a rear view of the fishing system.

FIG. 6 is a left side view of the fishing system.

FIG. 7 is a right side view of the fishing system.

FIG. 8 is an exploded view of the fishing system.

### DETAILED DESCRIPTION OF DIFFERENT EMBODIMENTS

A description of embodiments of the present disclosure will now be given with reference to the Figures. It is expected that the present disclosure may be embodied in other specific forms without departing from its spirit or essential characteristics. The described embodiments are to be considered in all respects only as illustrative and not restrictive. The scope of the disclosure is, therefore indicated by the appended claims rather than by the foregoing description. All changes that come within the meaning and range of equivalency of the claims are to be embraced within their scope.

The present disclosure relates to a multipurpose fishing box for carrying multiple fishing supplies and accessories required for a fishing trip, in one convenient container. The multipurpose fishing box is easily portable and provides a comfortable seating arrangement for resting during fishing. One of the most important aspect is the pivotally attached fishing pole holder, which allows fishing from a seated position. A wide range of fishing supplies and accessories stored in multiple storage compartments are readily accessible from a seated position. The multipurpose fishing box assembly of the present invention is also referred to as “fishing buddy” as the fishing box assembly comprises all aspects related to providing a complete fishing experience.

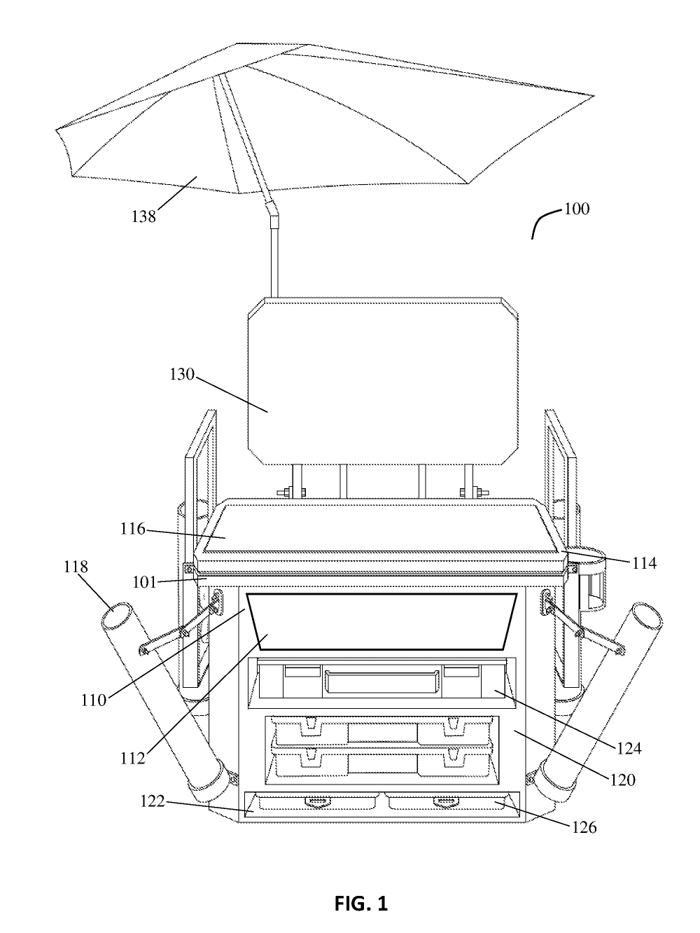

Referring to FIG. 1 illustrating a front view of the fishing system 100, which comprises an insulated fishing box 101 defining an upper compartment 110 and a lower compartment 120. The upper compartment 110 of the housing comprises a removable cooling chest 112, a lid 114 hingedly attached to a top edge of the housing and a cutting board 116 attached to an exterior surface of the lid 114. The fishing box 101 further comprises a cushion pad (not shown) removably attachable to the cutting board 116, to act as a cushion seat. The fishing system 100 further comprises at least one adjustable rod holder 118 pivotally attached to the front side or front corners of the housing for holding fishing rods or fishing lines. The adjustable rod holder 118 is configured to receive and hold the fishing rod in an undisturbed manner during fishing. The adjustable rod holder 118 provides a fishing experience, which requires only a limited use of hands. The angle of the fishing rod can be adjusted by moving the rod holder 118 towards front and backwards. The adjustable rod holder 118 can be adjusted to predefined angles based on factors such as water level, type of water body and the like.

In one embodiment, the fishing system 100 further comprises a backrest 130 hingedly attached to the fishing box 101 for a comfortable seating position and a foldable umbrella 140 mounted on the fishing box 101 for protecting from harsh weather such as during hot or sunny day. The lower compartment 120 of the fishing box 101 comprises a plurality of tray holders 122 for receiving fishing tackle trays 124 and bait boxes 126. The front portion of the fishing box 101 comprises a detachable wall covering the tray holders especially during transport.

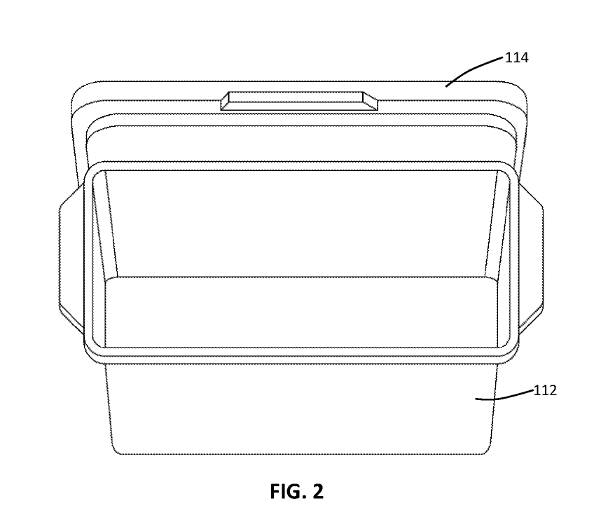

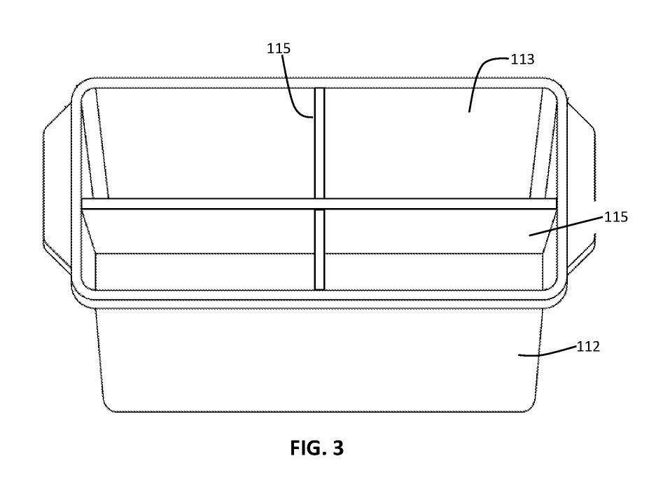

FIG. 2 shows a top perspective view of the cooling box 112 and a removable lid 114.The cooling box or cooling chest 112 allows storing of food and beverages, ice, water and bait. The cooling box 112 is removable for cleaning and sanitation purposes and can be used separately. The cooling box 112 is made of a material suitable for dishwasher and commonly used cleaning liquids. In an embodiment, the cooling box 112 comprises a plurality of compartments 113 formed by one or more dividers 115, as shown in FIG. 3.

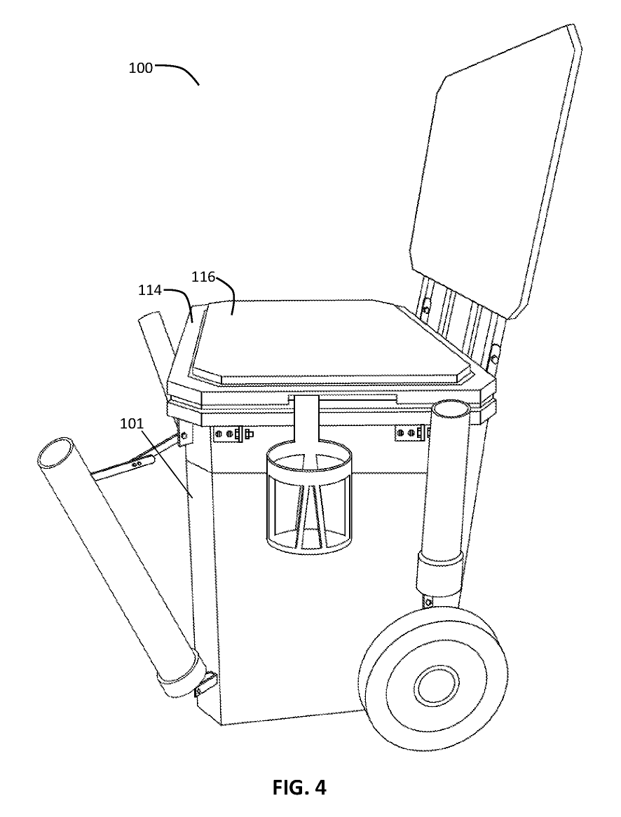

FIG. 4 is a side perspective view of the fishing system 100 comprising a cutting board 116 positioned above the lid 114 of the cooling box placed within the fishing box 101. The lid 114 may comprise an indented region on the top surface for receiving and holding the cutting board 116 in place. The intended region on the lid is designed in such a way that the height of the cutting board 116 is higher than the lid 114 surface.

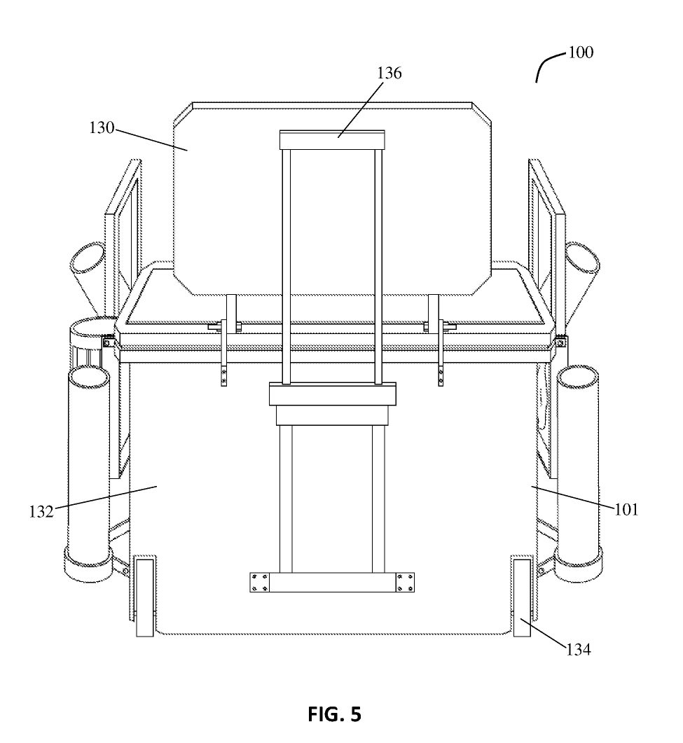

FIG. 5 shows a rear view of the fishing system 100 according to an embodiment of the present disclosure. The backrest 130 is foldably attached to a rear wall 132 of the fishing box 101, in such a way that allows folding of the backrest 130 when not in use and during transport. The rear wall 132 comprises at least a pair of wheels 134 attached to a bottom edge for easy transportation of the fishing system 100. A retractable handle 136 attached to the rear wall 132 for rolling the fishing box system, similar to moving a luggage.

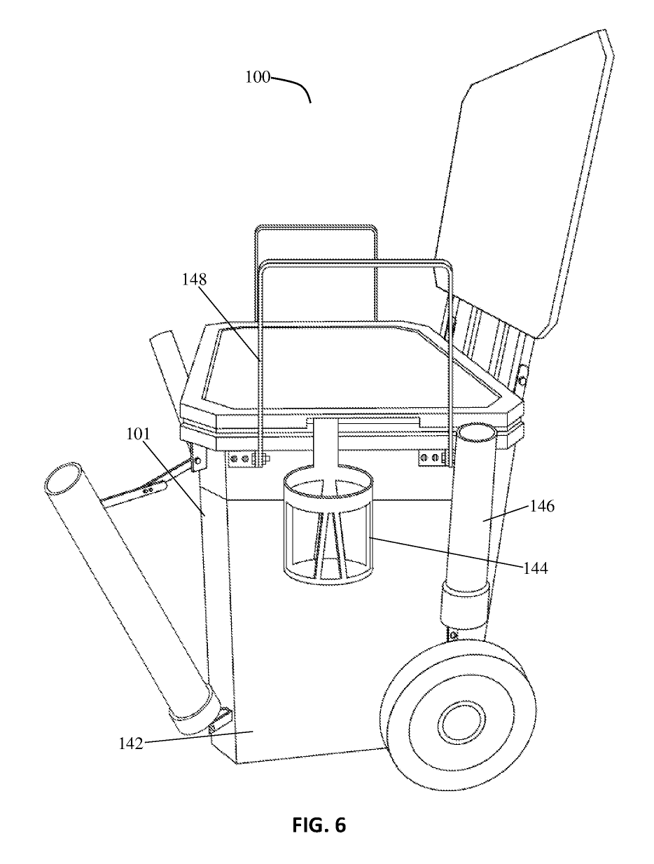

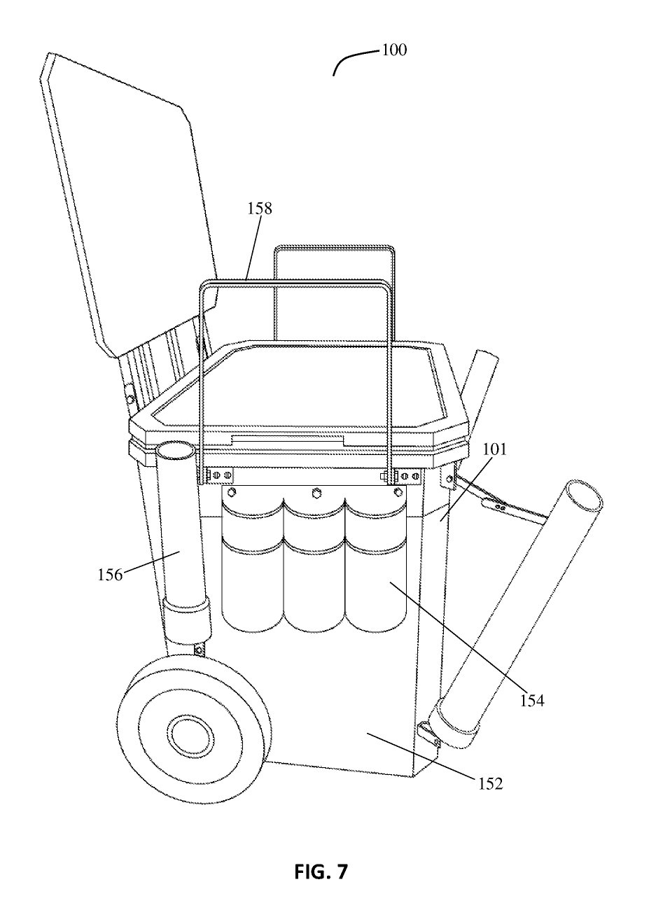

FIG. 6 and FIG. 7 shows the left side view and right side views respectively of the fishing system 100. The left sidewall 142 of the fishing box 101 comprises a beverage container holder 144 for holding beverage bottle or can, at least one fixed pole holder 146 for holding fishing pole or permit pole and a foldable armrest 148 which can be folded down towards the sidewall 142 when not in use. The right side wall 152 of the fishing box 101 comprises a tool bag 154 with a plurality of pouches for storing handy mechanical tools, wherein the tool bag 154 can be hanged on the sidewall 152. The right side wall 152 further comprises a fixed pole holder 156 for holding permit pole and a foldable armrest 158 which can be folded down towards the sidewall 152 when not in use. The foldable armrest 148, 158 can also serve as handles for lifting and carrying the fishing box 100.

The cooling chest 112 is configured to fit in the upper compartment 110 of the fishing box 101 and can be used for storing food and beverages. The cooling chest 112 may comprise a removable lid and one or more partitions dividing the inner area of the cooling chest 112 into multiple chambers for sorting and storing food materials. Completely separated cooling chest for holding provisions for food, drinks and ice, thus provides greater sanitation management against cross-contamination. The bottom wall of the fishing box 101 comprise raised edges or corners lined with a rubber material. The upper compartment 110 is separated from the lower compartment 120 by a removable insert, preferably made of clear plastic. The sidewalls 142, 152 further comprise one or more Bluetooth speaker to wirelessly connect with an electronic device such as MP3 player or mobile phone. In another embodiment, the fishing box 100 further comprises at least one live bait tank and an air pump for live bait tank.

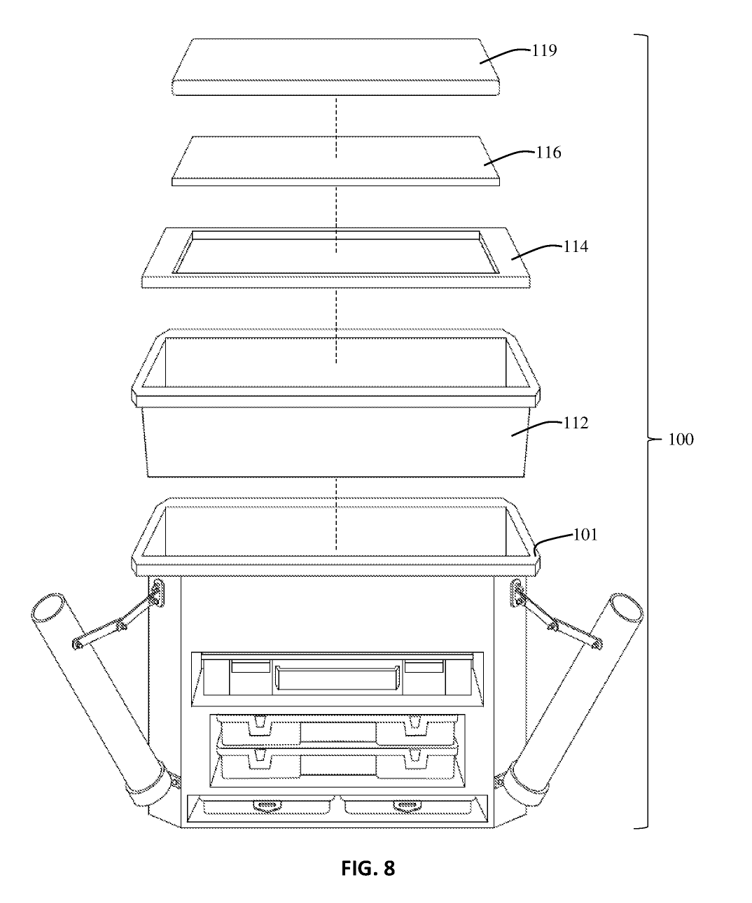

FIG. 8 shows an exploded view of the fishing system 100 showing the arrangement of the fishing box 101, cooling box 112 adapted to fit inside the fishing box 101, the removable lid 114 for the cooling box 112. The removable lid 112 comprises an indented region to receive the cutting board 116 and the cushion-padded seat 119 is positioned above the cutting board.

The fishing system 100 of the present disclosure allows placement and transport of multiple fishing supplies in one container. The fishing tackle and accessories are conveniently located in such a manner that the angler may reach for his supplies by remaining in a seated position while engaged in the fishing process. This is an improvement upon the existing portable coolers and tackle boxes, which necessitates one to raise from their seating position in order to obtain needed items that are stored beneath the seat or within a separate unit. In addition, the adjustable rod holder 118 allows user to adjust the fishing rod height according to the fishing area such as lake, river, or when fishing from a pier.

The fishing system 100 provides a seating arrangement comprising a bottom cushion pad and backrest providing the comfort of a chair. The cutting board 116 along with the cushion pad (not shown) covers the whole of the top of the upper compartment 110. In an embodiment, the lid 114 may comprise an additional cover foldably attached to the upper edge of the housing. The additional cover may comprise padded layer that can be lifted and positioned against the backrest 130 for additional comfort while leaning back.

The foregoing description comprise illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Many modifications and other embodiments of the disclosure will come to mind to one skilled in the art to which this disclosure pertains having the benefit of the teachings presented in the foregoing descriptions. Although specific terms may be employed herein, they are used only in generic and descriptive sense and not for purposes of limitation. Accordingly, the present disclosure is not limited to the specific embodiments illustrated herein.

What is claimed is:

1. A fishing system comprising:
an insulated housing defining an upper compartment and a lower compartment, wherein the upper compartment comprises a removable cooling chest, a lid hingedly attached to a top edge of the rear wall movable between an open position and a closed position, wherein the lid further comprises a cutting board attached to an exterior surface,
the lower compartment of the housing comprises a plurality of tray holders for receiving fishing tackle trays and bait boxes, at least a pair of wheels attached to a bottom of the housing for transportation of the fishing box;
a plurality of fishing pole holders pivotally attached to front corners of the housing, configured to receive and set fishing pole in predefined angles which allow fishing from a seated position; and
a plurality of beverage container holders attached to an exterior surface of the first sidewall and second sidewall.

2. The fishing system of claim 1, further comprises a backrest foldably attached to the rear wall.

3. The fishing system of claim 1, further comprises a cushion pad removably attached to the exterior of the lid.

4. The fishing system of claim 1, further comprises an arm rest pivotally attached to an upper edge of the first side wall and second side wall.

5. The fishing system of claim 1, further comprises a retractable handle attached to the rear wall of the housing.

6. The fishing system of claim 1, further comprises a Bluetooth speaker placed within the first sidewall and the second sidewall.

7. The fishing system of claim 1, further comprises an umbrella attached to the rear wall of the housing.

8. The fishing system of claim 1, wherein the cooling chest comprises a plurality of compartments for sorting and storing food and beverages.
